(19) United States
(12) Patent Application Publication
(10) Pub. No.: US 2004/0174255 A1
(43) Pub. Date: Sep. 9, 2004

(54) Inclement weather lighting system for vehicles

(76) Inventor: Ronald H. Banco, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 10/782,292

(22) Filed: Feb. 19, 2004

Related U.S. Application Data
(63) Continuation of application No. 10/008,149, filed on Nov. 5, 2001, now abandoned.

(51) Int. Cl. B60Q 1/26

(52) U.S. Cl. 340/468

(57) ABSTRACT

There is provided a vehicle with an inclement weather lighting system. The vehicle comprises a vehicle body having an inside and an outside defining a vehicle's rear. Positioned within the inside of the vehicle body is a safety light switch. Moreover, inclement weather lights, which are disposed on the vehicle's rear, is in electrical communication with the safety light switch. As such, when the safety light switch is activated, the inclement weather lights are operative to project at least one beam therefrom so as to alert ensuing vehicles during an inclement weather condition.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to a vehicular lighting system, and more particularly to an improved vehicular lighting system that utilizes inclement weather lights on a vehicle's rear to facilitate driving in inclement weather conditions such that the vehicle's presence, stopping or turning is more visually apparent to other vehicles on the highway.

The use of lighting systems on the road to increase visibility is well known. Due to the decreased visibility which is an inherent feature of darkness or inclement weather, it is desirable to increase visibility in order to prevent collisions with other motorists. As such, various lighting systems are employed, both to make other drivers more visible and to make the vehicle more visible to other drivers.

Automobiles are equipped with headlights for increasing the driver's ability to see objects in front of the car. The headlights of modern automobiles typically incorporate a “high beam” and “low beam” modes in which the lamps shine with particular brightness and angular orientation. However, headlights are of less use in inclement weather than they are in darkness because the light coming from the headlight tends to be refracted by the water, snow, or other content of the air. Additionally, light may be excessively reflected back to the driver so that the driver's vision is impaired. The latter problem is especially prevalent with headlight high beams, which are of little use in heavy fog conditions in particular.

Headlights also serve the purpose of making the vehicle more visible to oncoming drivers. However, headlights are only mounted on the front of cars and are of no use in this capacity as to drivers in the vehicle's rear quadrant. Accordingly, automobiles are also equipped with running lights mounted on the front sides and rear of the vehicle, which are activated when the vehicle's headlights are turned on. The running lights use a low power bulb to illuminate a typically red or amber filter, thus creating distinct points of illumination on the vehicle and increasing its visibility. However, running lights are low power and are often difficult to see through inclement weather. If the driver of the vehicle in front brakes suddenly there is a high probability of rear-end collision. Such probability may be even more enhanced given the situation created by the inclement weather condition (i.e., sleek roads, reduced visibility, etc.).

Various other prior art systems are in use to light vehicles. For instance, and as understood, U.S. Pat. Nos. 3,017,500 and 3,947,677 generally relate to designs which incorporate lights in the wheel well of cars for assisting in the changing of tires and for making the vehicle more visible while parked on the side of the road during an emergency. Moreover, U.S. Pat. No. 5,497,304 includes designs for side warning light systems which serve the general purpose of causing other drivers to perceive and respond to emergency situations. However, none of the prior art systems deals with the inclement weather difficulties addressed above. In particular, the prior art does not provide a means for making a vehicle more easily and actively visible to drivers in the vehicle's rear and side quadrant under inclement weather conditions.

Thus, there exists a substantial need in the industry, and in the automobile industry in particular, for a vehicular lighting system that would make a vehicle more visually apparent to ensuing vehicles on the highway during inclement weather conditions. Further, there exists a need for such vehicular lighting system which may be conveniently activated such that its utilization is user-friendly.

### BRIEF SUMMARY OF THE INVENTION

The present invention specifically addresses and overcomes the above-described deficiencies of prior art vehicular lighting systems by implementing an inclement weather lighting system on a vehicle's rear so as to make the vehicle more visually apparent to ensuing vehicles on the highway during inclement weather conditions. Moreover, the inclement weather lighting system of the present invention can be conveniently activated by a windshield wiper switch, fog light switch, or a separate switch mounted on the vehicle's dashboard via an electrical communication therebetween. In this respect, the present invention may be operated in a user-friendly manner to significantly reduce the risk of rear-end collisions during inclement weather conditions.

In accordance with a preferred embodiment of the present invention, there is provided an inclement weather lighting system adapted to alert ensuing vehicles during an inclement weather condition. In particular, the inclement weather lighting system serves to enhance the already-existing lights disposed on the vehicle's rear. More particularly, inclement weather lights are incorporated into conventional brake lights, directional lights, emergency lights, running lights and/or tail lights. This is accomplished by a second lamp, a second filament in the primary lamp, or even the existing filament which burns half bright normally and full bright when activated by the inclement weather lighting system.

In an alternate embodiment, the inclement weather lighting system may be defined as being at least one light emitter disposed on the vehicle's rear. The light emitter is preferably a fog light. More preferably, there are two fog lights which are laterally separated from each other on the vehicle's rear.

In the preferred embodiment of the present invention, the inclement weather lighting system is in electrical communication with a safety light switch disposed within a vehicle's inside. As they are electrically communicated to each other, the inclement weather lighting system can simply be energized into operation via the activation of the safety light switch. For the convenience of the user (i.e., driver), the safety light switch should be disposed around the user's reach such that it is easily accessible. As such, the safety light switch may be an independent switch mounted on a dashboard, or in the alternative, may be integrated into the windshield wiper or fog light switch. In this regard, the inclement weather lighting system can be activated simultaneously with vehicle safety gadgetry that is designed and often used for inclement weather conditions, such as the windshield wipers for example.

Various other safety measures may be taken, individually or in combination, with the inclement weather lighting system. One of such safety measures is to apply and use side running lights along the sides of the vehicle. The side running lights may be simultaneously activated with the inclement weather lighting system.

In operation, the user can simply activate the inclement weather lighting system from within the vehicle by selecting the safety switch. When activated, the inclement weather lighting system is operable to project out light beams therefrom away from the vehicle's rear. Of course, such system can be deactivated via the further selection of the safety light switch when the inclement weather condition is terminated.

### BRIEF DESCRIPTION OF THE DRAWINGS

These as well as other features of the present invention will become more apparent upon reference to the drawings wherein:

FIG. 1 is a perspective view of a vehicle with an inclement weather lighting system constructed in accordance with a preferred embodiment of the present invention and defining side running lights along the sides thereof;

FIG. 2 is an end view of the vehicle shown in FIG. 1 and illustrating active light emitters that are disposed on the rear thereof; and

FIG. 3 is an exploded end view of the vehicle's rear shown in FIG. 2 and illustrating a rear lights group which incorporates inclement weather lights therewith.

### DETAILED DESCRIPTION OF THE INVENTION

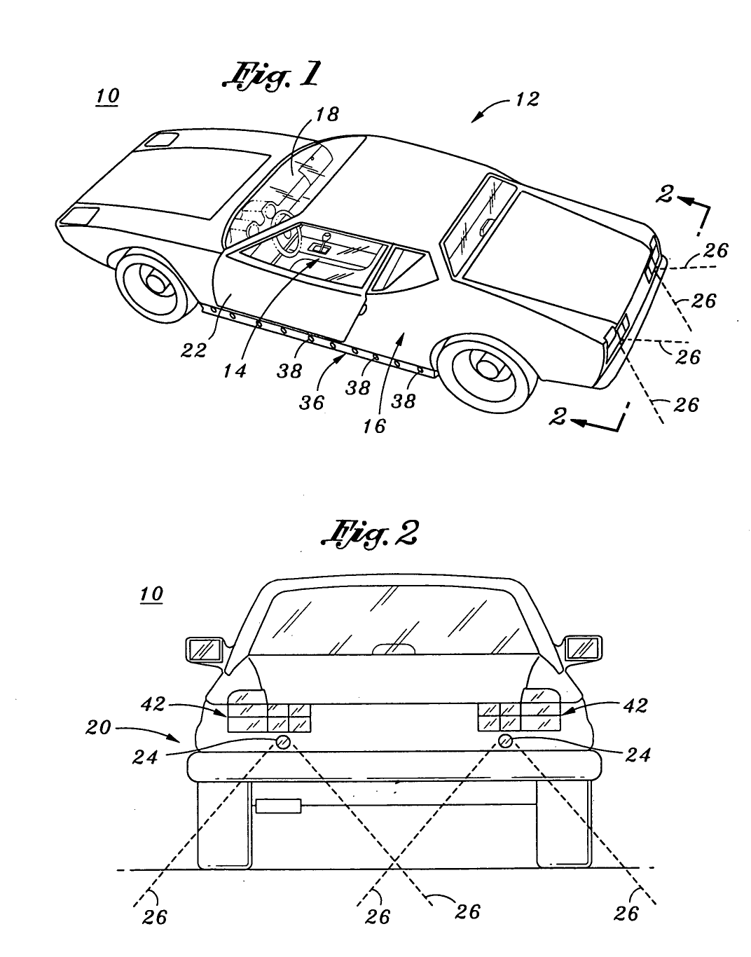

Referring now to the drawings wherein the showings are for purposes of illustrating preferred embodiments of the present invention only, and not for purposes of limiting the same, FIG. 1 perspectively illustrates a vehicle 10 with an inclement weather lighting system constructed in accordance with a preferred embodiment of the present invention. As will be recognized, the vehicle 10 is adapted to utilize such system to facilitate driving in inclement weather conditions such that the vehicle 10 is more visually apparent to ensuing vehicles on its rear quadrant on the highway.

It is worthwhile to first note that the inclement weather lighting system of the present invention may be configured for use with a variety of vehicles, such as an automobile, a boat, an airplane, a train, and the like. It is important to note that the automobile depicted in FIGS. 1-3 is only a symbolic representation of the vehicle 10, and the application of the present invention should not be solely limited thereto. It will be appreciated by those of ordinary skill in the art that the system of the present invention can be applicable to many types of vehicles.

Referring more particularly to FIGS. 1 and 3, the vehicle has a vehicle body 12. The vehicle body 12 is further described as having an inside 14 and an outside 16. As with most conventional vehicles, the vehicle's inside 14 is fitted to accommodate a user (e.g., a driver) such that the vehicle 10 can be controlled from within. The vehicle's inside 14 defines a dashboard 18 among other internal components to facilitate the achievement of such purpose. In addition, the vehicle's outside 16 comprises a front, a rear 20, and two sides 22 placed therebetween.

The inclement weather lighting system is used to alert ensuing vehicles during an inclement weather condition. As such, in one embodiment of the present invention, the inclement weather lighting system serves to enhance the lights of the rear lights groups 40 disposed on the vehicle's rear. More particularly, inclement weather lights (“iwl”) can be incorporated into conventional brake lights, directional lights, emergency lights, running lights and/or tail lights. This may be accomplished by adding a second lamp into each light of the rear lights groups 42, or adding a second filament in the exisitng primary lamp. In the alternative, filaments which burn half bright normally and full bright when activated may be incorporated thereto.

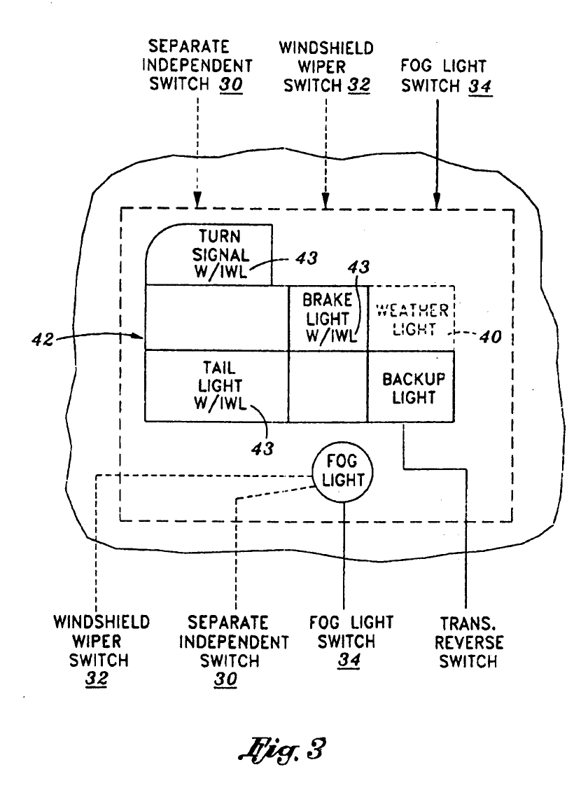

In an alternate embodiment, the inclement weather lighting system includes at least one fog light 24 disposed on the vehicle's rear 20. As shown in FIGS. 2 and 3, the fog lights 24 are suited to facilitate the objective of the present invention of mitigating rear-end collisions during inclement weather conditions because they are active light emitters designed to project beams 26 outwardly so as to enhance visibility to their surroundings. Preferably, there are two fog lights 24 thereat but it will be recognized that only one may be sufficient to achieve the above purpose. When there are two fog lights 24, they should be laterally and distantly separated from each other on the vehicle's rear 20 to the extent that their projected beams 26 do not substantially overlap. Moreover, the fog lights 24 can be introduced on the vehicle's rear 20 when the vehicle 10 is manufactured such that the rear 20 is conformed to accommodate the fog lights 24 thereto, such as providing complimentary openings for positioning the fog lights 24 therein so as to emit projected beams 26 therethrough (best shown in FIG. 2). Or, in the alternative, the rearwardly-disposed fog lights 24 may be retrofitted to an already manufactured vehicle (e.g., engaging the fog lights underneath a rear bumper section via fasteners).

Referring now to FIG. 3, the inclement weather lighting system is electrically communicated to a safety light switch 28 disposed within the vehicle's inside 14. As the electrical communication is established therebetween, the system can be activated via the user's selection of the safety light switch 28. For the convenience of the user (i.e., driver), the safety light switch 28 should be positioned within the user's reach so as to facilitate its accessibility. In this respect, the safety light switch 28 may take the form of a separate independent switch 30 mounted on a dashboard 18. Alternatively, the safety light switch 28 may be integrated into a windshield wiper switch 32 or a fog light switch 34. In this manner, the inclement weather lighting system may be activated simultaneously with other vehicle safety gadgetry (e.g., windshield wipers) that is often used during inclement weather conditions. Furthermore, it will be recognized by those of ordinary skill in the art that electrical communication may be established between the system and the safety light switch 28 via known conventional methods, or any slight creative modifications thereof.

Referring now to FIG. 1, the inclement weather lighting system may further comprise side running lights 36 which can be used in combination therewith. The side running lights 36 may be engaged along each of the two sides 22 of the vehicle body 12 for operation with the inclement weather lighting system. More specifically, the side running lights 36 that are engaged, or formed, on respective ones of the opposing vehicle's sides 22 may be electrically communicated to the safety light switch 28 in the manner similar to the inclement weather lighting system. Like such system, electrical communication may be laid between the safety light switch 28 and the side running lights 36 by any known conventional methods, or creative derivations thereof. However, since simultaneous activation of the side running lights 36 with the inclement weather lighting system is desired, it is preferable that the electrical connection of the side running lights 36 is incorporated into the electrical connection established between the safety light switch 28 and the system. As such, the safety light switch 28, the inclement weather lighting system and the side running lights 36 may collectively share one common electrical connection. It would be an obvious variation, however, to lay out a separate electrical connection for the side running lights 36.

The side running lights 36 may take the form of elongated light beam bodies that have sturdy, transparent outer shells. In this respect, bright bulbs may be formed at each ends of the lights beam bodies within the shell such that their illuminations reflect upon the entirety of the transparent shell, and thus make them visible from outside. Alternatively, each of the side running lights 36 may comprise a plurality of lights 38 which are collectively arranged in a line formation therealong and are further jointly activatable via the safety light switch 28 so as to illuminate thereby. Each of the plurality of lights 38 may be individually replaced when its usage life is terminated. Either way, it is the concept of illuminating the vehicle's sides 22 for the purpose of visually alerting other vehicles and pedestrians on the highway that should be appreciated.

Referring more particularly to FIG. 3, the inclement weather lighting system may further comprise weather lights 40 which are simultaneously operable with the inclement weather lights 43 via the activation of the safety light switch 28. The weather lights 40 may each be incorporated into the respective rear lights groups 42 disposed on the vehicle's rear 20. The placement of the weather light 40 as depicted in FIG. 3 is exemplary in nature as it may be positioned in any of the slots defined by its respective rear lights group 42. It is the concept of illumination in combination with the light beam emission from the inclement weather lights 43 for betterment of visualization that should be appreciated.

More specifically, the weather lights 40 should be electrically communicated to the safety light switch 28 such that its energization and activation are synchronized with that of the inclement weather lights 43. It may further be operative for simultaneous use with the side running lights 36 in addition to the inclement weather lights 43. As such, it is preferred that the weather lights 40 are electrically connected to the communication shared between the safety light switch 28 and the inclement weather lighting system. Of course, like above, such connection may easily be accomplished via known conventional methods.

In operation, when the inclement weather condition is observed, the user can simply activate the inclement weather lighting system from the vehicle's inside 14 by selecting and activating the safety light switch 28. The inclement weather conditions may be defined as any of the naturally occurring weather conditions that are deemed unfriendly to driving, such as fogs, heavy rains, heavy snows and the like. When activated, the rearwardly-disposed fog light 24 is operable to emit projected light beam 26 therefrom away from the vehicle's rear 20. Of course, the inclement weather lighting system should be deactivated via the further selection of the safety light switch 28 when the inclement weather condition is terminated.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A method of utilizing an inclement weather lighting system adapted for a vehicle, the system having at least one fog light disposed on a vehicle's rear, the method comprising the steps of:
a) observing an inclement weather condition;
b) selecting a safety light switch;
c) projecting at least one beam from the at least one fog light disposed on the vehicle's rear in response to the safety light switch selection; and
d) alerting other vehicles located in proximity to the vehicle's rear via the at least one beam projection from the at least one fog light.

2. The method of claim 1 further comprising the step of:
e) deactivating the at least one fog light when the inclement weather condition is terminated.

3. The method of claim 1 wherein step b) comprises:
1) defining a vehicle's inside;
2) determining a windshield wiper switch disposed within the vehicle's inside as the safety light switch; and
3) activating the windshield wiper switch.

4. The method of claim 1 wherein step b) comprises:
1) defining a vehicle's inside;
2) determining a fog light switch disposed within the vehicle's inside as the safety light switch; and
3) activating the fog light switch.

5. The method of claim 1 wherein step c) comprises:
1) communicating the at least one fog light with the safety light switch;
2) energizing the at least one fog light via the selection of the safety light switch; and
3) emitting the at least one beam from the at least one fog light away from the vehicle's rear.

6. The method of claim 1 wherein step c) further comprises:
1) defining two opposing vehicles's sides;
2) communicating two side running lights formed on respective ones of the opposing vehicles's sides with the safety light switch;
3) energizing the two side running lights via the selection of the safety light switch; and
4) illuminating a plurality of lights placed on each one of the two side running lights.

7. The method of claim 1 wherein the at least one fog light comprises two fog lights.

8. A method of utilizing an inclement weather lighting system adapted for a vehicle, the system having a plurality of inclement weather lights formed on each rear lights groups of a vehicle's rear, the method comprising the steps of:
a) observing an inclement weather condition;
b) selecting a safety light switch;
c) illuminating the plurality of inclement weather lights formed on each of the rear lights groups in response to the safety light switch selection; and
d) alerting other vehicles located in proximity to the vehicle's rear via the illumination of inclement weather lights.

9. The method of claim 8 wherein each of the rear lights groups comprise a brake light, a tail light, and a turn signal light.

10. The method of claim 8 wherein the inclement weather lights are filaments.

11. The method of claim 8 wherein step c) further comprises:
1) defining a weather light formed on each of the rear lights groups;
2) communicating each of the weather lights with the safety light switch;
3) energizing each of the weather lights via the selection of the safety light switch; and
4) illuminating each of the weather lights so as to provide additional visual notification to the other vehicles during the inclement weather condition.

12. A vehicle with an inclement weather lighting system adapted to alert ensuing vehicles during an inclement weather condition, the vehicle comprising:
a vehicle body having an inside and an outside, the outside of the vehicle body defining a rear;
a safety light switch positioned within the inside of the vehicle body; and
at least one fog light disposed on the rear and in electrical communication with the safety light switch, the at least one fog light being operative to project at least one beam away from the rear via activation of the safety light switch so as to alert the ensuing vehicles during the inclement weather condition.

13. The vehicle of claim 12 wherein the safety light switch is a windshield wiper switch.

14. The vehicle of claim 12 wherein the safety light switch is a fog light switch.

15. The vehicle of claim 12 wherein the safety light switch is mounted upon a dashboard disposed within the inside of the vehicle body.

16. The vehicle of claim 12 wherein the at least one fog light comprises two fog lights.

17. The vehicle of claim 16 wherein the two fog lights are laterally separated from each other.

18. The vehicle of claim 12 wherein the vehicle body comprises two opposing sides each having a side running light in electrical communication with the safety light switch, each of the side running lights defining a plurality of lights therealong operative to illuminate via the activation of the safety light switch.

19. The vehicle of claim 12 wherein the rear comprises two rear lights groups each having a weather light, the weather lights being in electrical communication with the safety light switch so as to illuminate when the safety light switch is activated.
